(19) United States
(12) Patent Application Publication
(10) Pub. No.: US 2015/0066345 A1
(43) Pub. Date: Mar. 5, 2015

(54) VEHICLE COLLISION MANAGEMENT SYSTEM RESPONSIVE TO USER-SELECTED PREFERENCES

(71) Applicant: Elwha LLC, Bellevue, WA (US)

(72) Inventors: Jesse R. Cheatham, III, Seattle, WA (US); Roderick A. Hyde, Redmond, WA (US); Edward K.Y. Jung, Bellevue, WA (US); Jordin T. Kare, Seattle, WA (US); Conor L. Myhrvold, Medina, WA (US); Robert C. Petroski, Seattle, WA (US); Clarence T. Tegreene, JR., Mercer Island, WA (US); Lowell L. Wood, JR., Bellevue, WA (US)

(21) Appl. No.: 14/012,695

(22) Filed: Aug. 28, 2013

(51) Int. Cl. G08G 1/16

(52) U.S. Cl. CPC G08G 1/16
USPC 701/301

(57) ABSTRACT

Described embodiments include a system, method, and vehicle. A system includes a collision management algorithm that includes preferences utilizable in determining a management of a possible collision between a collision-managed vehicle and an external object. A preference includes a vehicle collision management preference inputted by a human user of the collision-managed vehicle. The system includes a damage mitigation circuit configured to determine in at least substantially real time a collision mitigation strategy applicable to the collision-managed vehicle. The collision mitigation strategy is determined in response to (i) the collision management algorithm with the inputted vehicle collision management preference incorporated therein, and (ii) a predicted likelihood of a collision between the collision-managed vehicle and a particular external object. The system includes an instruction generator circuit configured to generate collision management instruction responsive to the determined collision mitigation strategy.

If an Application Data Sheet (ADS) has been filed on the filing date of this application, it is incorporated by reference herein. Any applications claimed on the ADS for priority under 35 U.S.C. §§119, 120, 121, or 365(c), and any and all parent, grandparent, great-grandparent, etc. applications of such applications, are also incorporated by reference, including any priority claims made in those applications and any material incorporated by reference, to the extent such subject matter is not inconsistent herewith.

### CROSS-REFERENCE TO RELATED APPLICATIONS

The present application claims the benefit of the earliest available effective filing date(s) from the following listed application(s) (the “Priority Applications”), if any, listed below (e.g., claims earliest available priority dates for other than provisional patent applications or claims benefits under 35 USC §119(e) for provisional patent applications, for any and all parent, grandparent, great-grandparent, etc. applications of the Priority Application(s)). In addition, the present application is related to the “Related Applications,” if any, listed below.

### PRIORITY APPLICATIONS

None.

### RELATED APPLICATIONS

U.S. patent application Ser. No. ______, entitled VEHICLE COLLISION MANAGEMENT SYSTEM RESPONSIVE TO A SITUATION OF AN OCCUPANT OF AN APPROACHING VEHICLE, naming Jessie R. Cheatham III, Roderick A. Hyde, Edward K. Y. Jung, Jordin T. Kare, Conor L. Myhrvold, Robert C. Petroski, Clarence T. Tegreene, and Lowell L. Wood, Jr. as inventors, filed Aug. 28, 2013 with attorney docket no. 0513-035-003-000000, is related to the present application.

If the listings of applications provided above are inconsistent with the listings provided via an ADS, it is the intent of the Applicant to claim priority to each application that appears in the Priority Applications section of the ADS and to each application that appears in the Priority Applications section of this application.

All subject matter of the Priority Applications and the Related Applications and of any and all parent, grandparent, great-grandparent, etc. applications of the Priority Applications and the Related Applications, including any priority claims, is incorporated herein by reference to the extent such subject matter is not inconsistent herewith.

### SUMMARY

For example, and without limitation, an embodiment of the subject matter described herein includes a system. The system includes a collision management algorithm having a rule-set that includes preferences utilizable in determining a management of a possible collision between a collision-managed vehicle and an external object. A preference of the rule-set includes a vehicle collision management preference inputted by a human user of the collision-managed vehicle. In an embodiment, the preferences are utilizable in determining a best management of a possible collision between a collision-managed vehicle and an external object. The system includes a damage mitigation circuit configured to determine in at least substantially real time a collision mitigation strategy applicable to the collision-managed vehicle. The collision mitigation strategy is determined in response to (i) the collision management algorithm with the inputted vehicle collision management preference incorporated therein, and (ii) a predicted likelihood of a collision between the collision-managed vehicle and a particular external object. The system includes an instruction generator circuit configured to generate collision management instruction responsive to the determined collision mitigation strategy.

In an embodiment, the system includes a computer readable storage media. In an embodiment, the system includes a situation circuit configured to predict in at least substantially real time the likelihood of a collision between the collision-managed vehicle and the external object. The prediction is responsive to data indicative of an environment or situation external or internal to the collision-managed vehicle. In an embodiment, the system includes a receiver circuit configured to receive the human user inputted vehicle collision management preference for the collision-managed vehicle. In an embodiment, the system includes a first sensor configured to acquire data indicative of an environment or situation internal to the collision-managed vehicle. In an embodiment, the system includes a second sensor configured to acquire data indicative of an environment or situation external to the collision-managed vehicle. In an embodiment, the system includes a reporting system configured to output a human perceivable report indicating an active vehicle collision management preference.

For example, and without limitation, an embodiment of the subject matter described herein includes a system. The system includes a damage mitigation circuit configured to determine in at least substantially real time a collision mitigation strategy applicable to a collision-managed vehicle. The collision mitigation strategy is determined in response to a collision management algorithm having a rule-set that includes preferences utilizable in determining a best management of a possible collision between the collision-managed vehicle and an external object. The collision mitigation strategy is also determined in response to a vehicle collision management preference inputted by a human user of the collision-managed vehicle. The collision mitigation strategy is also determined in response to a predicted likelihood of a collision between the collision-managed vehicle and the external object. The system includes an instruction generator circuit configured to generate a collision management instruction responsive to the determined collision mitigation strategy.

For example, and without limitation, an embodiment of the subject matter described herein includes a method. The method includes integrating a collision management preference inputted by a human user of a collision-managed vehicle into a rule-set of a collision management algorithm. The rule-set including preferences utilizable in determining a management of a possible collision between the collision-managed vehicle and an external object. The method includes determining in at least substantially real time a collision mitigation strategy applicable to the collision-managed vehicle. The collision mitigation strategy is determined in response to the collision management algorithm with the integrated user inputted collision management preference. The method includes generating a collision management instruction responsive to the determined collision mitigation strategy.

In an embodiment, the method includes receiving the collision management preference. In an embodiment, the method includes sensing data indicative of an environment or situation internal to the collision-managed vehicle. In an embodiment, the method includes sensing data indicative of an environment or situation external of the collision-managed vehicle. In an embodiment, the method includes predicting in at least substantially real time the likelihood of a collision between the collision-managed vehicle and the external object. The prediction is responsive to data indicative of an environment or situation external or internal to the collision-managed vehicle.

For example, and without limitation, an embodiment of the subject matter described herein includes a collision-managed vehicle. The collision-managed vehicle includes a vehicle operations controller configured to control at least one of a propulsion system, a steering system, or a braking system of the collision-managed vehicle in response to a collision management instruction. The collision-managed vehicle includes a collision management system. The collision management system includes a collision management algorithm having a rule-set that includes preferences utilizable in determining a management of a possible collision between a collision-managed vehicle and an external object. A preference of the rule-set includes a vehicle collision management preference inputted by a human user of the collision-managed vehicle. The collision management system includes a damage mitigation circuit configured to determine in at least substantially real time a collision mitigation strategy applicable to the collision-managed vehicle. The collision mitigation strategy is determined in response to the collision management algorithm with the inputted vehicle collision management preference incorporated therein. The collision management system includes an instruction generator circuit configured to generate the collision management instruction responsive to the determined collision mitigation strategy and to output the collision management instruction to the vehicle operations controller.

In an embodiment, the collision management system includes a receiver circuit configured to receive the vehicle collision management preference inputted by the human user. In an embodiment, the collision management system includes a reporting system configured to output a human perceivable report indicating an active vehicle collision management preference.

The foregoing summary is illustrative only and is not intended to be in any way limiting. In addition to the illustrative aspects, embodiments, and features described above, further aspects, embodiments, and features will become apparent by reference to the drawings and the following detailed description.

### BRIEF DESCRIPTION OF THE DRAWINGS

FIG. 1 illustrates an example embodiment of an environment 19 that includes a thin computing device 20 in which embodiments may be implemented;

FIG. 2 illustrates an example embodiment of an environment 100 that includes a general-purpose computing system 110 in which embodiments may be implemented;

FIG. 3 schematically illustrates an example environment 200 in which embodiments may be implemented;

FIG. 4 illustrates an example operational flow 300;

FIG. 5 illustrates an embodiment of the operational flow 300 of FIG. 4;

FIG. 6 schematically illustrates an environment 400 in which embodiments may be implemented;

FIG. 7 illustrates an example operational flow 500;

FIG. 8 illustrates an alternative embodiment of the operational flow 500 of FIG. 7;

FIG. 9 illustrates an example operational flow 600; and

FIG. 10 illustrates an alternative embodiment of the operational flow 600 of FIG. 9.

### DETAILED DESCRIPTION

In the following detailed description, reference is made to the accompanying drawings, which form a part hereof. In the drawings, similar symbols typically identify similar components, unless context dictates otherwise. The illustrated embodiments described in the detailed description, drawings, and claims are not meant to be limiting. Other embodiments may be utilized, and other changes may be made, without departing from the spirit or scope of the subject matter presented here.

Those having skill in the art will recognize that the state of the art has progressed to the point where there is little distinction left between hardware, software, and/or firmware implementations of aspects of systems; the use of hardware, software, and/or firmware is generally (but not always, in that in certain contexts the choice between hardware and software can become significant) a design choice representing cost vs. efficiency tradeoffs. Those having skill in the art will appreciate that there are various implementations by which processes and/or systems and/or other technologies described herein can be effected (e.g., hardware, software, and/or firmware), and that the preferred implementation will vary with the context in which the processes and/or systems and/or other technologies are deployed. For example, if an implementer determines that speed and accuracy are paramount, the implementer may opt for a mainly hardware and/or firmware implementation; alternatively, if flexibility is paramount, the implementer may opt for a mainly software implementation; or, yet again alternatively, the implementer may opt for some combination of hardware, software, and/or firmware. Hence, there are several possible implementations by which the processes and/or devices and/or other technologies described herein may be effected, none of which is inherently superior to the other in that any implementation to be utilized is a choice dependent upon the context in which the implementation will be deployed and the specific concerns (e.g., speed, flexibility, or predictability) of the implementer, any of which may vary. Those skilled in the art will recognize that optical aspects of implementations will typically employ optically-oriented hardware, software, and or firmware.

In some implementations described herein, logic and similar implementations may include software or other control structures suitable to implement an operation. Electronic circuitry, for example, may manifest one or more paths of electrical current constructed and arranged to implement various logic functions as described herein. In some implementations, one or more media are configured to bear a device-detectable implementation if such media hold or transmit a special-purpose device instruction set operable to perform as described herein. In some variants, for example, this may manifest as an update or other modification of existing software or firmware, or of gate arrays or other programmable hardware, such as by performing a reception of or a transmission of one or more instructions in relation to one or more operations described herein. Alternatively or additionally, in some variants, an implementation may include special-purpose hardware, software, firmware components, and/or general-purpose components executing or otherwise invoking special-purpose components. Specifications or other implementations may be transmitted by one or more instances of tangible transmission media as described herein, optionally by packet transmission or otherwise by passing through distributed media at various times.

Alternatively or additionally, implementations may include executing a special-purpose instruction sequence or otherwise invoking circuitry for enabling, triggering, coordinating, requesting, or otherwise causing one or more occurrences of any functional operations described below. In some variants, operational or other logical descriptions herein may be expressed directly as source code and compiled or otherwise invoked as an executable instruction sequence. In some contexts, for example, C++ or other code sequences can be compiled directly or otherwise implemented in high-level descriptor languages (e.g., a logic-synthesizable language, a hardware description language, a hardware design simulation, and/or other such similar mode(s) of expression). Alternatively or additionally, some or all of the logical expression may be manifested as a Verilog-type hardware description or other circuitry model before physical implementation in hardware, especially for basic operations or timing-critical applications. Those skilled in the art will recognize how to obtain, configure, and optimize suitable transmission or computational elements, material supplies, actuators, or other common structures in light of these teachings.

In a general sense, those skilled in the art will recognize that the various embodiments described herein can be implemented, individually and/or collectively, by various types of electro-mechanical systems having a wide range of electrical components such as hardware, software, firmware, and/or virtually any combination thereof and a wide range of components that may impart mechanical force or motion such as rigid bodies, spring or torsional bodies, hydraulics, electro-magnetically actuated devices, and/or virtually any combination thereof. Consequently, as used herein “electro-mechanical system” includes, but is not limited to, electrical circuitry operably coupled with a transducer (e.g., an actuator, a motor, a piezoelectric crystal, a Micro Electro Mechanical System (MEMS), etc.), electrical circuitry having at least one discrete electrical circuit, electrical circuitry having at least one integrated circuit, electrical circuitry having at least one application specific integrated circuit, electrical circuitry forming a general purpose computing device configured by a computer program (e.g., a general purpose computer configured by a computer program which at least partially carries out processes and/or devices described herein, or a microprocessor configured by a computer program which at least partially carries out processes and/or devices described herein), electrical circuitry forming a memory device (e.g., forms of memory (e.g., random access, flash, read only, etc.)), electrical circuitry forming a communications device (e.g., a modem, module, communications switch, optical-electrical equipment, etc.), and/or any non-electrical analog thereto, such as optical or other analogs. Those skilled in the art will also appreciate that examples of electro-mechanical systems include but are not limited to a variety of consumer electronics systems, medical devices, as well as other systems such as motorized transport systems, factory automation systems, security systems, and/or communication/computing systems. Those skilled in the art will recognize that electro-mechanical as used herein is not necessarily limited to a system that has both electrical and mechanical actuation except as context may dictate otherwise.

In a general sense, those skilled in the art will also recognize that the various aspects described herein which can be implemented, individually and/or collectively, by a wide range of hardware, software, firmware, and/or any combination thereof can be viewed as being composed of various types of “electrical circuitry.” Consequently, as used herein “electrical circuitry” includes, but is not limited to, electrical circuitry having at least one discrete electrical circuit, electrical circuitry having at least one integrated circuit, electrical circuitry having at least one application specific integrated circuit, electrical circuitry forming a general purpose computing device configured by a computer program (e.g., a general purpose computer configured by a computer program which at least partially carries out processes and/or devices described herein, or a microprocessor configured by a computer program which at least partially carries out processes and/or devices described herein), electrical circuitry forming a memory device (e.g., forms of memory (e.g., random access, flash, read only, etc.)), and/or electrical circuitry forming a communications device (e.g., a modem, communications switch, optical-electrical equipment, etc.). Those having skill in the art will recognize that the subject matter described herein may be implemented in an analog or digital fashion or some combination thereof.

Those skilled in the art will further recognize that at least a portion of the devices and/or processes described herein can be integrated into an image processing system. A typical image processing system may generally include one or more of a system unit housing, a video display device, memory such as volatile or non-volatile memory, processors such as microprocessors or digital signal processors, computational entities such as operating systems, drivers, applications programs, one or more interaction devices (e.g., a touch pad, a touch-sensitive screen or display surface, an antenna, etc.), control systems including feedback loops and control motors (e.g., feedback for sensing lens position and/or velocity; control motors for moving/distorting lenses to give desired focuses). An image processing system may be implemented utilizing suitable commercially available components, such as those typically found in digital still systems and/or digital motion systems.

Those skilled in the art will likewise recognize that at least some of the devices and/or processes described herein can be integrated into a data processing system. Those having skill in the art will recognize that a data processing system generally includes one or more of a system unit housing, a video display device, memory such as volatile or non-volatile memory, processors such as microprocessors or digital signal processors, computational entities such as operating systems, drivers, graphical user interfaces, and applications programs, one or more interaction devices (e.g., a touch pad, a touch-sensitive screen or display surface, an antenna, etc.), and/or control systems including feedback loops and control motors (e.g., feedback for sensing position and/or velocity; control motors for moving and/or adjusting components and/or quantities). A data processing system may be implemented utilizing suitable commercially available components, such as those typically found in data computing/communication and/or network computing/communication systems.

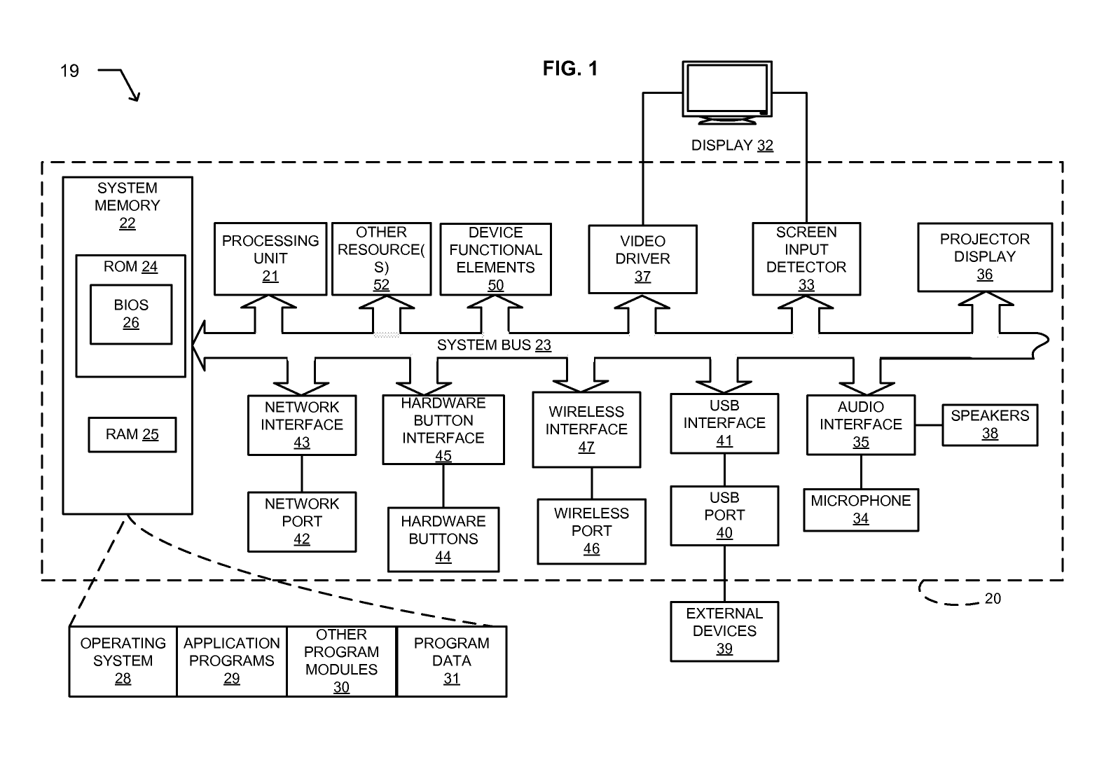

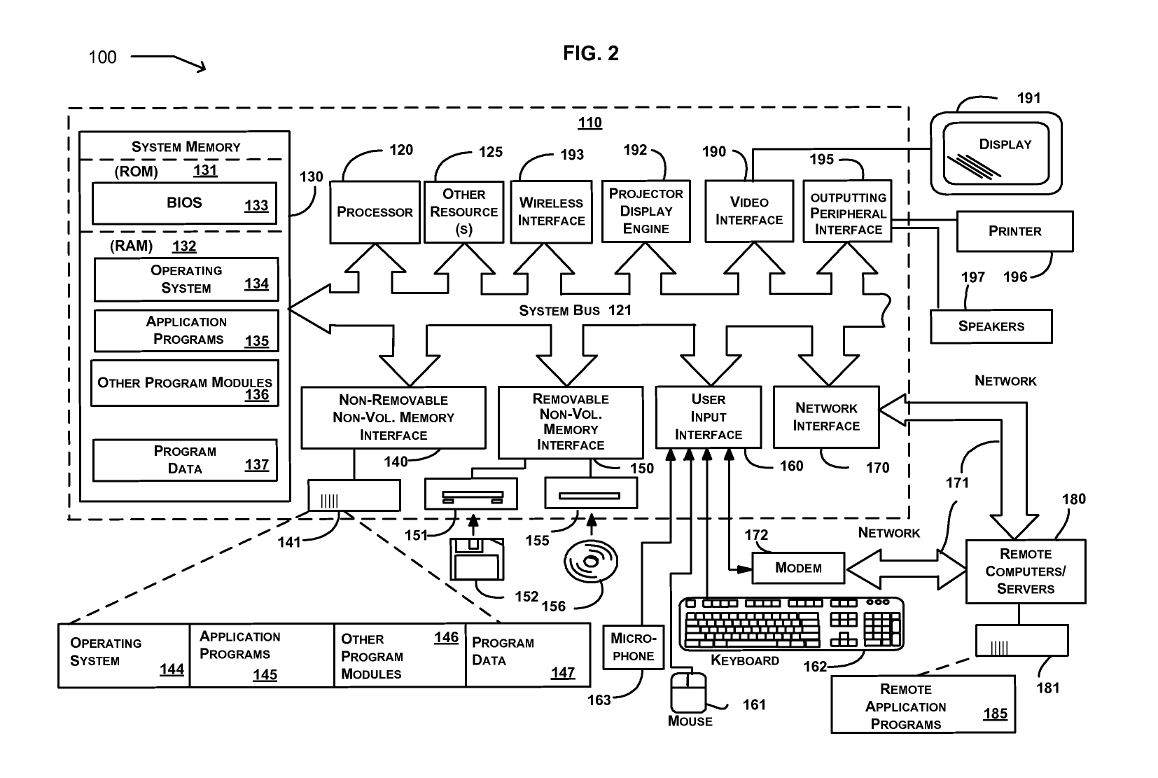

FIGS. 1 and 2 provide respective general descriptions of several environments in which implementations may be implemented. FIG. 1 is generally directed toward a thin computing environment 19 having a thin computing device 20, and FIG. 2 is generally directed toward a general purpose computing environment 100 having general purpose computing device 110. However, as prices of computer components drop and as capacity and speeds increase, there is not always a bright line between a thin computing device and a general purpose computing device. Further, there is a continuous stream of new ideas and applications for environments benefited by use of computing power. As a result, nothing should be construed to limit disclosed subject matter herein to a specific computing environment unless limited by express language.

FIG. 1 and the following discussion are intended to provide a brief, general description of a thin computing environment 19 in which embodiments may be implemented. FIG. 1 illustrates an example system that includes a thin computing device 20, which may be included or embedded in an electronic device that also includes a device functional element 50. For example, the electronic device may include any item having electrical or electronic components playing a role in a functionality of the item, such as for example, a refrigerator, a car, a digital image acquisition device, a camera, a cable modem, a printer an ultrasound device, an x-ray machine, a non-invasive imaging device, or an airplane. For example, the electronic device may include any item that interfaces with or controls a functional element of the item. In another example, the thin computing device may be included in an implantable medical apparatus or device. In a further example, the thin computing device may be operable to communicate with an implantable or implanted medical apparatus. For example, a thin computing device may include a computing device having limited resources or limited processing capability, such as a limited resource computing device, a wireless communication device, a mobile wireless communication device, a smart phone, an electronic pen, a handheld electronic writing device, a scanner, a cell phone, a smart phone (such as an Android® or iPhone® based device), a tablet device (such as an iPad®) or a Blackberry® device. For example, a thin computing device may include a thin client device or a mobile thin client device, such as a smart phone, tablet, notebook, or desktop hardware configured to function in a virtualized environment.

The thin computing device 20 includes a processing unit 21, a system memory 22, and a system bus 23 that couples various system components including the system memory 22 to the processing unit 21. The system bus 23 may be any of several types of bus structures including a memory bus or memory controller, a peripheral bus, and a local bus using any of a variety of bus architectures. The system memory includes read-only memory (ROM) 24 and random access memory (RAM) 25. A basic input/output system (BIOS) 26, containing the basic routines that help to transfer information between sub-components within the thin computing device 20, such as during start-up, is stored in the ROM 24. A number of program modules may be stored in the ROM 24 or RAM 25, including an operating system 28, one or more application programs 29, other program modules 30 and program data 31.

A user may enter commands and information into the computing device 20 through one or more input interfaces. An input interface may include a touch-sensitive screen or display surface, or one or more switches or buttons with suitable input detection circuitry. A touch-sensitive screen or display surface is illustrated as a touch-sensitive display 32 and screen input detector 33. One or more switches or buttons are illustrated as hardware buttons 44 connected to the system via a hardware button interface 45. The output circuitry of the touch-sensitive display 32 is connected to the system bus 23 via a video driver 37. Other input devices may include a microphone 34 connected through a suitable audio interface 35, or a physical hardware keyboard (not shown). Output devices may include the display 32, or a projector display 36.

In addition to the display 32, the computing device 20 may include other peripheral output devices, such as at least one speaker 38. Other external input or output devices 39, such as a joystick, game pad, satellite dish, scanner or the like may be connected to the processing unit 21 through a USB port 40 and USB port interface 41, to the system bus 23. Alternatively, the other external input and output devices 39 may be connected by other interfaces, such as a parallel port, game port or other port. The computing device 20 may further include or be capable of connecting to a flash card memory (not shown) through an appropriate connection port (not shown). The computing device 20 may further include or be capable of connecting with a network through a network port 42 and network interface 43, and through wireless port 46 and corresponding wireless interface 47 may be provided to facilitate communication with other peripheral devices, including other computers, printers, and so on (not shown). It will be appreciated that the various components and connections shown are examples and other components and means of establishing communication links may be used.

The computing device 20 may be primarily designed to include a user interface. The user interface may include a character, a key-based, or another user data input via the touch sensitive display 32. The user interface may include using a stylus (not shown). Moreover, the user interface is not limited to an actual touch-sensitive panel arranged for directly receiving input, but may alternatively or in addition respond to another input device such as the microphone 34. For example, spoken words may be received at the microphone 34 and recognized. Alternatively, the computing device 20 may be designed to include a user interface having a physical keyboard (not shown).

The device functional elements 50 are typically application specific and related to a function of the electronic device, and are coupled with the system bus 23 through an interface (not shown). The functional elements may typically perform a single well-defined task with little or no user configuration or setup, such as a refrigerator keeping food cold, a cell phone connecting with an appropriate tower and transceiving voice or data information, a camera capturing and saving an image, or communicating with an implantable medical apparatus.

In certain instances, one or more elements of the thin computing device 20 may be deemed not necessary and omitted. In other instances, one or more other elements may be deemed necessary and added to the thin computing device.

FIG. 2 and the following discussion are intended to provide a brief, general description of an environment in which embodiments may be implemented. FIG. 2 illustrates an example embodiment of a general-purpose computing system in which embodiments may be implemented, shown as a computing system environment 100. Components of the computing system environment 100 may include, but are not limited to, a general purpose computing device 110 having a processor 120, a system memory 130, and a system bus 121 that couples various system components including the system memory to the processor 120. The system bus 121 may be any of several types of bus structures including a memory bus or memory controller, a peripheral bus, and a local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnect (PCI) bus, also known as Mezzanine bus.

The computing system environment 100 typically includes a variety of computer-readable media products. Computer-readable media may include any media that can be accessed by the computing device 110 and include both volatile and nonvolatile media, removable and non-removable media. By way of example, and not of limitation, computer-readable media may include computer storage media. By way of further example, and not of limitation, computer-readable media may include a communication media.

Computer storage media includes volatile and nonvolatile, removable and non-removable media implemented in any method or technology for storage of information such as computer-readable instructions, data structures, program modules, or other data. Computer storage media includes, but is not limited to, random-access memory (RAM), read-only memory (ROM), electrically erasable programmable read-only memory (EEPROM), flash memory, or other memory technology, CD-ROM, digital versatile disks (DVD), or other optical disk storage, magnetic cassettes, magnetic tape, magnetic disk storage, or other magnetic storage devices, or any other medium which can be used to store the desired information and which can be accessed by the computing device 110. In a further embodiment, a computer storage media may include a group of computer storage media devices. In another embodiment, a computer storage media may include an information store. In another embodiment, an information store may include a quantum memory, a photonic quantum memory, or atomic quantum memory. Combinations of any of the above may also be included within the scope of computer-readable media.

Communication media may typically embody computer-readable instructions, data structures, program modules, or other data in a modulated data signal such as a carrier wave or other transport mechanism and include any information delivery media. The term “modulated data signal” means a signal that has one or more of its characteristics set or changed in such a manner as to encode information in the signal. By way of example, and not limitation, communications media may include wired media, such as a wired network and a direct-wired connection, and wireless media such as acoustic, RF, optical, and infrared media.

The system memory 130 includes computer storage media in the form of volatile and nonvolatile memory such as ROM 131 and RAM 132. A RAM may include at least one of a DRAM, an EDO DRAM, a SDRAM, a RDRAM, a VRAM, or a DDR DRAM. A basic input/output system (BIOS) 133, containing the basic routines that help to transfer information between elements within the computing device 110, such as during start-up, is typically stored in ROM 131. RAM 132 typically contains data and program modules that are immediately accessible to or presently being operated on by the processor 120. By way of example, and not limitation, FIG. 2 illustrates an operating system 134, application programs 135, other program modules 136, and program data 137. Often, the operating system 134 offers services to applications programs 135 by way of one or more application programming interfaces (APIs) (not shown). Because the operating system 134 incorporates these services, developers of applications programs 135 need not redevelop code to use the services. Examples of APIs provided by operating systems such as Microsoft's “WINDOWS” ® are well known in the art.

The computing device 110 may also include other removable/non-removable, volatile/nonvolatile computer storage media products. By way of example only, FIG. 2 illustrates a non-removable non-volatile memory interface (hard disk interface) 140 that reads from and writes for example to non-removable, non-volatile magnetic media. FIG. 2 also illustrates a removable non-volatile memory interface 150 that, for example, is coupled to a magnetic disk drive 151 that reads from and writes to a removable, non-volatile magnetic disk 152, or is coupled to an optical disk drive 155 that reads from and writes to a removable, non-volatile optical disk 156, such as a CD ROM. Other removable/non-removable, volatile/non-volatile computer storage media that can be used in the example operating environment include, but are not limited to, magnetic tape cassettes, memory cards, flash memory cards, DVDs, digital video tape, solid state RAM, and solid state ROM. The hard disk drive 141 is typically connected to the system bus 121 through a non-removable memory interface, such as the interface 140, and magnetic disk drive 151 and optical disk drive 155 are typically connected to the system bus 121 by a removable non-volatile memory interface, such as interface 150.

The drives and their associated computer storage media discussed above and illustrated in FIG. 2 provide storage of computer-readable instructions, data structures, program modules, and other data for the computing device 110. In FIG. 2, for example, hard disk drive 141 is illustrated as storing an operating system 144, application programs 145, other program modules 146, and program data 147. Note that these components can either be the same as or different from the operating system 134, application programs 135, other program modules 136, and program data 137. The operating system 144, application programs 145, other program modules 146, and program data 147 are given different numbers here to illustrate that, at a minimum, they are different copies.

A user may enter commands and information into the computing device 110 through input devices such as a microphone 163, keyboard 162, and pointing device 161, commonly referred to as a mouse, trackball, or touch pad. Other input devices (not shown) may include at least one of a touch-sensitive screen or display surface, joystick, game pad, satellite dish, and scanner. These and other input devices are often connected to the processor 120 through a user input interface 160 that is coupled to the system bus, but may be connected by other interface and bus structures, such as a parallel port, game port, or a universal serial bus (USB).

A display 191, such as a monitor or other type of display device or surface may be connected to the system bus 121 via an interface, such as a video interface 190. A projector display engine 192 that includes a projecting element may be coupled to the system bus. In addition to the display, the computing device 110 may also include other peripheral output devices such as speakers 197 and printer 196, which may be connected through an output peripheral interface 195.

The computing system environment 100 may operate in a networked environment using logical connections to one or more remote computers, such as a remote computer 180. The remote computer 180 may be a personal computer, a server, a router, a network PC, a peer device, or other common network node, and typically includes many or all of the elements described above relative to the computing device 110, although only a memory storage device 181 has been illustrated in FIG. 2. The network logical connections depicted in FIG. 2 include a local area network (LAN) and a wide area network (WAN), and may also include other networks such as a personal area network (PAN) (not shown). Such networking environments are commonplace in offices, enterprise-wide computer networks, intranets, and the Internet.

When used in a networking environment, the computing system environment 100 is connected to the network 171 through a network interface, such as the network interface 170, the modem 172, or the wireless interface 193. The network may include a LAN network environment, or a WAN network environment, such as the Internet. In a networked environment, program modules depicted relative to the computing device 110, or portions thereof, may be stored in a remote memory storage device. By way of example, and not limitation, FIG. 2 illustrates remote application programs 185 as residing on memory storage device 181. It will be appreciated that the network connections shown are examples and other means of establishing a communication link between the computers may be used.

In certain instances, one or more elements of the computing device 110 may be deemed not necessary and omitted. In other instances, one or more other elements may be deemed necessary and added to the computing device.

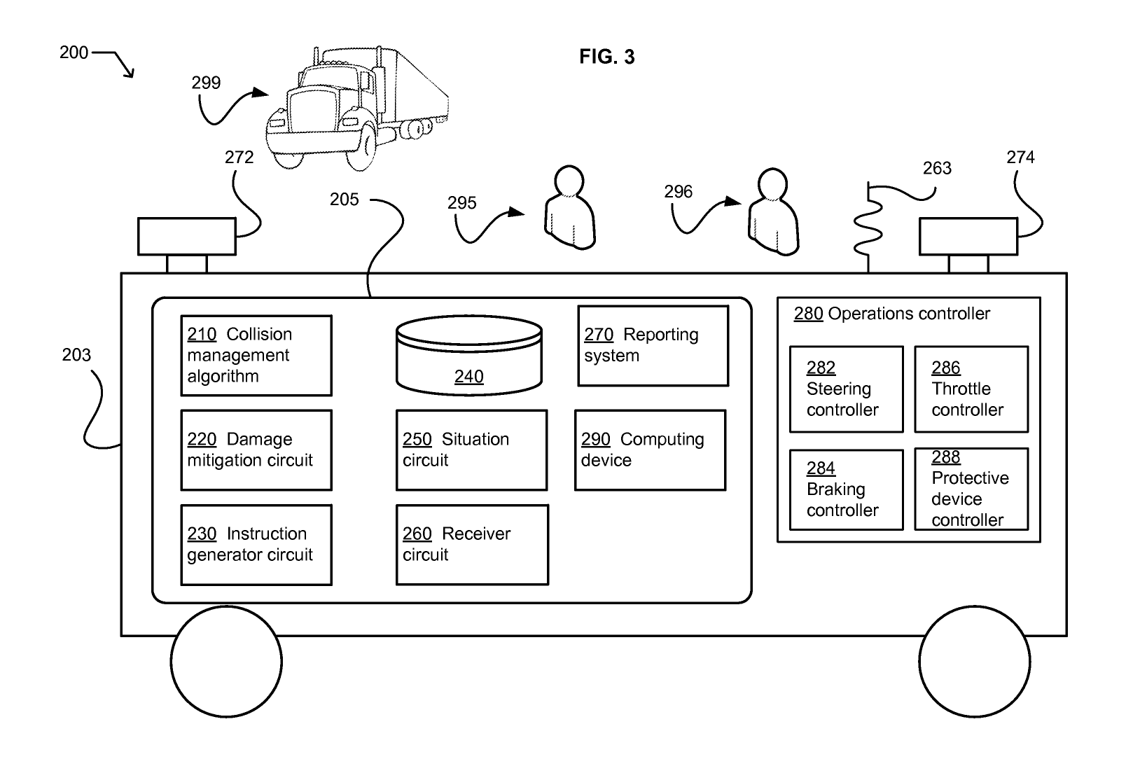

FIG. 3 schematically illustrates an example environment 200 in which embodiments may be implemented. The environment includes a system 205, a collision-managed vehicle 203, and a human user 295 of the collision-managed vehicle. The human user may include an owner or driver, or a passenger occupying the collision-managed vehicle. Another human user is illustrated as a human user 296. The system includes a computer readable storage media 240 storing a collision management algorithm 210. The collision management algorithm has a rule-set that includes preferences utilizable in determining a management of a possible collision between the collision-managed vehicle and an external object. The external object is illustrated by a truck 299. A preference of the rule-set includes a vehicle collision management preference inputted by the human user of the collision-managed vehicle. In an embodiment, the determining a management of a possible collision includes determining a best management of a possible collision. In an embodiment, a preference of the rule-set incorporates the vehicle management preference into the rule-set. For example, a vehicle management preference may include a relative preference to collide with a dumpster over a child. For example, a vehicle management preference may include a relative preference to collide with a child only as a last resort.

The system 205 includes a damage mitigation circuit 220 configured to determine in at least substantially real time a collision mitigation strategy applicable to the collision-managed vehicle 203. The collision mitigation strategy is determined in response to (i) the collision management algorithm 210 with the inputted vehicle collision management preference incorporated therein and (ii) a predicted likelihood of a collision between the collision-managed vehicle and a particular external object. The system includes an instruction generator circuit 230 configured to generate a collision management instruction responsive to the determined collision mitigation strategy. For example, the collision management instruction may include an instruction to steer away from a child, or to steer toward a Jersey barrier. For example, the collision management instruction may further include an instruction to apply maximum braking after an initial portion of the steering toward a Jersey barrier is achieved. For example, the collision management instruction may further include initiation of an occupant protection device such as an airbag in anticipation of a collision with the Jersey barrier.

In an embodiment, the human user includes the driver 295 or the passenger 296 of the collision-managed vehicle 203. In an embodiment, the human user includes a present or future driver or passenger of the collision-managed vehicle. In an embodiment, the collision-managed vehicle includes a motor vehicle.

In an embodiment, the vehicle collision management preference includes personalized rules addressing different types of external objects, maneuvering limits in avoiding external objects, or levels of risk posed by external objects. In an embodiment, the vehicle collision management preference includes a relative preference of a collision with an inanimate external object, such as a car, truck, embankment, barrier, or telephone pole over a human being or animal. For example, a relative preference may include a polarity, such as prefer to hit an object verses an animal or human. For example, a relative preference may include an extent, such as a weighing is given hitting an object verses an animal or human. For example, a relative preference may include a weighing of harm to each object, such as a bruise to a human verses a death of an animal. In an embodiment, the vehicle collision management preference includes a relative preference of a collision with an animal over a human being, such as a pedestrian. In an embodiment, the vehicle collision management preference includes a relative preference of a collision with one type or category of a human over another type or category of a human. For example, a relative preference may include colliding with an adult human over a child, or a man over woman, or an older human over a young human. In an embodiment, the vehicle collision management preference includes a relative preference of a collision with non-domesticated animals, such as cattle, over domesticated animals, such as a dog or cat. In an embodiment, the vehicle collision management preference includes a relative preference of a collision with an external object that impacts an impact absorbing zone of the collision-managed vehicle over a collision that impacts non-impact absorbing zone. In an embodiment, the vehicle collision management preference includes a relative preference of a collision with an external object impacting a region having a deployable impact absorbing device of the collision-managed vehicle over a region not having a deployable impact absorbing device. For example, a deployable impact absorbing device may include an exterior or interior air bag. In an embodiment, the vehicle collision management preference includes a relative preference of a collision impacting a low kinetic energy external object, such as dumpster, over a high kinetic energy object, such as a logging truck. In an embodiment, the vehicle collision management preference includes a relative preference of a collision mode having a lower peak impulse flux density over a collision mode having a higher peak impulse flux density. In an embodiment, the vehicle collision management preference includes a relative preference of a collision impacting a roadside safety system, such as a Jersey barrier, over a hazardous roadside feature, such as a cliff or rock wall. In an embodiment, the vehicle collision management preference includes a relative preference of a collision mode having lower likelihood of a severe trauma to an occupant of the collision-managed vehicle 203 over a collision mode having a higher likelihood of a severe trauma to the occupant. For example, a relative preference of a rear-end collision over a head-on collision. In an embodiment, the vehicle collision management preference includes a relative preference of a collision with an external object impacting a region of the collision-managed vehicle occupied by a robust human over a region of the collision-managed vehicle occupied by an at-risk or infirm human. For example, an at-risk or infirm human may include an infant, a frail human, or a human otherwise having a low ability to absorb an impact.

In an embodiment, the vehicle collision management preference includes a relative preference of a collision causing financial damage below a threshold value to the collision-managed vehicle over hitting an animal. In an embodiment, the threshold value is responsive to the predicted likelihood of a collision between the collision-managed vehicle and the animal. In an embodiment, the vehicle collision management preference includes a relative preference of a collision impacting a protected occupant over an unprotected occupant. In an embodiment, the vehicle collision management preference includes a relative preference of a collision adversely impacting an occupant of the collision-managed vehicle over a pedestrian. In an embodiment, the vehicle collision management preference includes a relative preference of limiting a potential injury to an occupant of the collision-managed vehicle caused by an avoidance maneuver over a potential injury due to a collision with the external object. For example, not attempting a high g-force collision avoidance maneuver that may harm all vehicle occupants over a collision at an impact zone proximate to an occupant protected by an airbag. In an embodiment, the vehicle collision management preference includes a limit on G-forces imparted to the human user or other occupant of the collision-managed vehicle. For example, occupants of the collision-managed vehicle may each have a specified g-force limit preference. For example, if the human user is an active professional football player, they likely are better able to absorb high g-force collision and may enter a preference having a higher g-force impact and a complex maneuver, such as spin to a rear end impact, while a relatively frail human user may enter a preference with a lower g-force impact and a simple maneuver of a straight-ahead crash into a grocery store. In an embodiment, the vehicle collision management preference includes a relative preference of conditionally avoiding some objects. For example, cars may be normally avoided, but may, in some cases, be hit rather than evaded. In an embodiment, the vehicle collision management preference includes a preference on maneuvering limits, on acceptable collision severity, on treating personal damage versus property damage, on how to treat different obstacles, or on protection countermeasures. In an embodiment, the vehicle collision management preference includes a preference responsive to a likelihood of the collision-managed vehicle actually being able to implement the mitigation strategy. For example, a possible mitigation strategy may only have a 10% likelihood of being accomplished, so the preference shifts the determination to a strategy having a higher likelihood of being accomplished.

In an embodiment, the vehicle collision management preference includes a vehicle collision management preference entered manually by the human user 295 prior to putting the collision-managed vehicle 203 in motion. In an embodiment, the vehicle collision management preference includes a vehicle collision management preference entered in a game-like simulation. For example, a game-like simulation may include presenting one or more situations and responding to choices made by the human user to the presented situations. For example, the human user may be presented with a slider bar to set weights. In an embodiment, the vehicle collision management preference includes a vehicle collision management preference stored in a computer readable storage media 240 carried by the collision-managed vehicle. In an embodiment, the vehicle collision management preference includes a vehicle collision management preference stored in a key fob, cellular phone, or RFID tag carryable by the human user.

In an embodiment, the system 205 includes the computer readable storage media 240 further configured to store the vehicle collision management preference inputted by the human user. In an embodiment, the rule-set of the collision mitigation algorithm is further responsive to an extent or difficulty of a maneuver required to prevent a collision with the external object. In an embodiment, the rule-set of the collision mitigation algorithm is further responsive to a risk of another collision to another external object associated with an avoidance maneuver. For example, a blind lane change may be considered too risky. For example, a situation where another driver's reactions will lead to unavoidable danger may be considered risky. In an embodiment, the rule-set of the collision mitigation algorithm is further responsive to a prioritization among multiple external objects that may potentially be hit. For example, the prioritizing including being more willing to hit an animal than a car, or more willing to hit a car than a pedestrian. In an embodiment, the collision mitigation strategy is further determined in response to (iii) data indicative of an environment or situation external to the collision-managed vehicle.

In an embodiment, the instruction generator circuit 230 is further configured to output the collision management instruction to an operations controller 280 of the collision-managed vehicle 203 configured to implement the collision management instruction. In an embodiment, the operations controller includes a steering controller 282 of the collision-managed vehicle. In an embodiment, the operations controller includes a braking controller 284 of the collision-managed vehicle. In an embodiment, the operations controller includes a throttle controller 286 of the collision-managed vehicle. In an embodiment, the operations controller includes a protective device controller 288 of the collision-managed vehicle. For example, a protective device may include an airbag protecting an occupant, a seat belt tensioner, an external airbag, or an external kinetic energy absorber.

In an embodiment, the system 205 includes a situation circuit 250 configured to predict in at least substantially real time the likelihood of a collision between the collision-managed vehicle 203 and the external object 299. The prediction is responsive to data indicative of an environment or situation external or internal to the collision-managed vehicle. In an embodiment, the system includes a receiver circuit 260 configured to receive the human user inputted vehicle collision management preference for the collision-managed vehicle. In an embodiment, the receiver circuit is configured to wirelessly receive 263 the human user inputted vehicle collision management preference. In an embodiment, the receiver circuit is configured to receive the human user inputted vehicle collision management preference from a user input device operably coupled to the system. For example, the user input device may include the hardware buttons 44, the external devices 39, or a touch screen version of the display 32 of the thin computing device 20 described in conjunction with FIG. 1. For example, the user input device may include the keyboard 162, the mouse 161, or a touch screen version of the display 191 of the general purpose computing device described in conjunction with FIG. 2. For example, the human user may occupy the collision-managed vehicle at the time the vehicle collision management preference is inputted or received. For example, the human user may occupy the collision-managed vehicle at some time after the vehicle collision management preference is inputted or received.

In an embodiment, the system includes a first sensor 272 configured to acquire data indicative of an environment or situation internal to the collision-managed vehicle 203. In an embodiment, the first sensor is configured to be mounted on or carried by a vehicle to be collision-managed. In an embodiment, the first sensor is configured to sense a location in the collision-managed vehicle of one or more occupants. In an embodiment, the system includes a second sensor 274 configured to acquire data indicative of an environment or situation external to the collision-managed vehicle. In an embodiment, the second sensor is configured to be mounted on or carried by a vehicle to be collision-managed. In an embodiment, the second sensor is configured to acquire data indicative a human or animal external to the collision-managed vehicle. In an embodiment, the second sensor is further configured to identify or classify the human or animal. In an embodiment, the second sensor is configured to acquire data indicative another vehicle proximate to the collision-managed vehicle. In an embodiment, the second sensor is further configured to identify or classify the another vehicle. In an embodiment, the second sensor is further configured to identify or classify at least one external object proximate to the collision-managed vehicle. For example, the identifying or classifying may include differentiating a pedestrian from an animal, a box, or a car. In an embodiment, the second sensor is further configured to identify or classify at least one external object proximate to the collision-managed vehicle in response to an identifier borne or transmitted by the at least one external object.

In an embodiment, the system 205 may be implemented in whole or in part by a computing device 290. For example, the computing device may be implemented in whole or in part using the thin computing device 20 described in conjunction with FIG. 1, and or by the general purpose computing device 110 described in conjunction with FIG. 2.

In an embodiment, the system 205 includes a reporting system 270 configured to output a human perceivable report indicating an active vehicle collision management preference. For example, the reporting system may report to the vehicle owner, the human user, or occupant what preferences are active. For example, the reporting may be in response to a query. For example, the reporting may occur in response to a change of a preference. For example, the reporting may occur upon a driver taking over a car with preferences not set by them. In an embodiment, the reporting system may include a reporting circuit configured to generate data indicative of one or more active vehicle collision management preferences. The report may be displayed by an on-board display, such as the display 32 of the thin computing device 20 described in conjunction with FIG. 1, or such as by the display 191 of the general purpose computing device 110 described in conjunction with FIG. 2. In an embodiment, the report may be available for uploading to a smart phone or other wireless device used by the vehicle owner, the human user, or occupant.

FIG. 3 also illustrates an alternative embodiment of the system 205. In this alternative embodiment, the system includes the damage mitigation circuit 220. The damage mitigation circuit is configured to determine in at least substantially real time a collision mitigation strategy applicable to the collision-managed vehicle 203. The collision mitigation strategy is determined in response to (i) the collision management algorithm 210 having a rule-set that includes preferences utilizable in determining a best management of a possible collision between the collision-managed vehicle and an external object 299. The collision mitigation strategy is also determined in response to (ii) a vehicle collision management preference inputted by the human user 295 of the collision-managed vehicle, and (iii) a predicted likelihood of a collision between the collision-managed vehicle and the external object. The system includes the instruction generator circuit 230 configured to generate a collision management instruction responsive to the determined collision mitigation strategy.

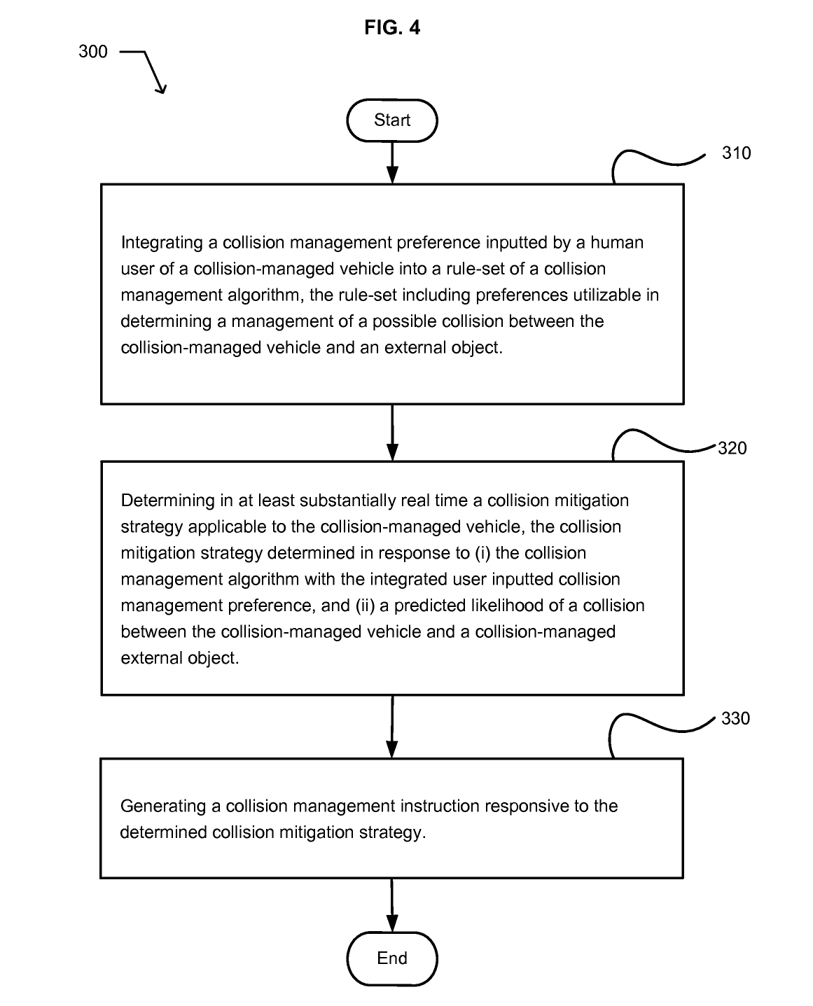

FIG. 4 illustrates an example operational flow 300 implemented in a computing device. After a start operation, the operational flow includes an incorporation operation 310. The incorporation operation includes integrating a collision management preference inputted by a human user of a collision-managed vehicle into a rule-set of a collision management algorithm. The rule-set includes preferences utilizable in determining a management of a possible collision between the collision-managed vehicle and an external object. In an embodiment, the preferences are utilizable in determining a best management of a possible collision between the collision-managed vehicle and an external object. In an embodiment, the human user includes a present or a future user of the collision-managed vehicle. In an embodiment, the incorporation operation may be implemented by the receiver circuit 260 receiving the collision management preference inputted by the human user 295, and the computing device 290 incorporating the received collision management preference into the rule-set of the collision management algorithm 210 stored on the computer readable media 240 described in conjunction with FIG. 3. A strategizing operation 320 includes determining in at least substantially real time a collision mitigation strategy applicable to the collision-managed vehicle. The collision mitigation strategy is determined in response to (i) the collision management algorithm with the integrated user inputted collision management preference, and (ii) a predicted likelihood of a collision between the collision-managed vehicle and a particular external object. In an embodiment, the strategizing operation may be implemented using the damage mitigation circuit 220 described in conjunction with FIG. 3. An implementation operation 330 includes generating a collision management instruction responsive to the determined collision mitigation strategy. In an embodiment, the implementation operation may be implemented using the instruction generator circuit 230 described in conjunction with FIG. 3. The operational flow includes an end operation.

For example, in use, the operational flow 300 is performed while the collision-managed vehicle is in motion, for example, along a street, highway, or parking lot. In an embodiment of the strategizing operation 320, the collision mitigation strategy is further determined in response to data indicative of an environment or situation external or internal to the collision-managed vehicle.

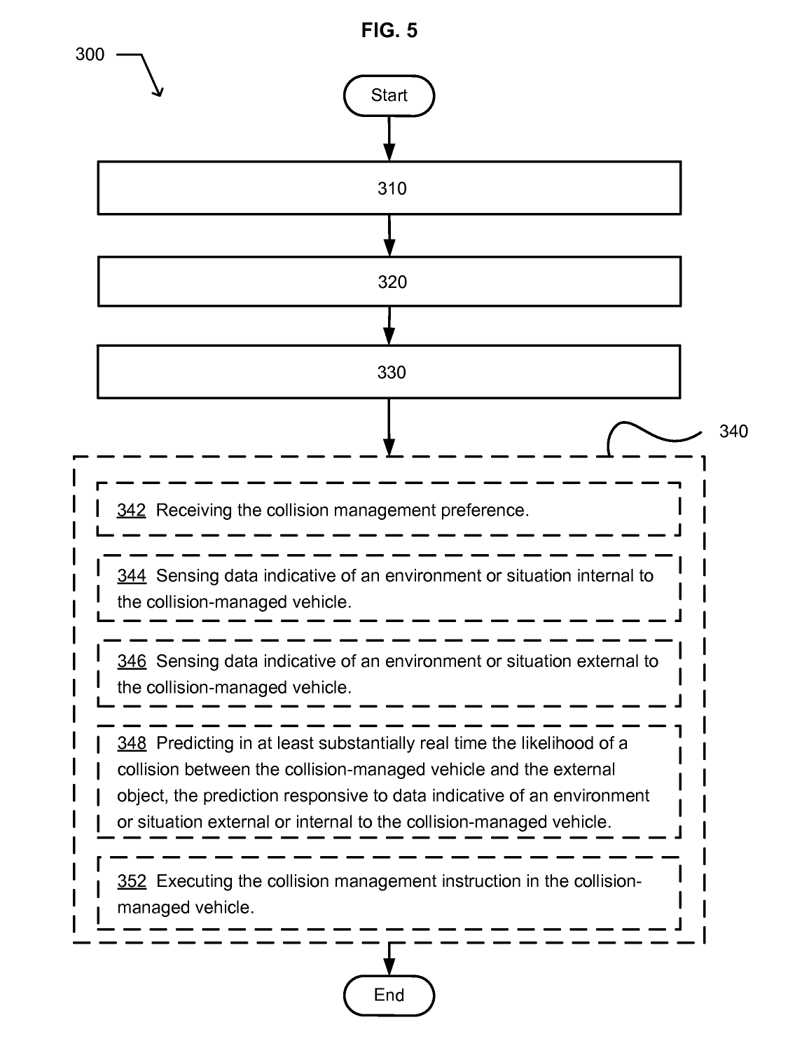

FIG. 5 illustrates an embodiment of the operational flow 300 described in conjunction with FIG. 4. In an embodiment, the operational flow may include at least one additional operation 340. The at least one additional operation may include an operation 342, an operation 344, an operation 346, an operation 348, or an operation 352. The operation 342 includes receiving the collision management preference. The operation 344 includes sensing data indicative of an environment or situation internal to the collision-managed vehicle. The operation 346 includes sensing data indicative of an environment or situation external to the collision-managed vehicle. The operation 348 includes predicting in at least substantially real time the likelihood of a collision between the collision-managed vehicle and the external object. The prediction is responsive to data indicative of an environment or situation external or internal to the collision-managed vehicle. The operation 352 includes executing the collision management instruction in the collision-managed vehicle.

Returning to FIG. 3, FIG. 3 also illustrates an embodiment of the collision-managed vehicle 203. The collision-managed vehicle includes the vehicle operations controller 280. The vehicle operations controller is configured to control at least one of a propulsion system, a steering system, or a braking system of the collision-managed vehicle in response to a collision management instruction. In an embodiment, the vehicle operations controller may include a steering controller 282, a braking controller 284, a throttle controller 286, or a protective device controller 288. The collision-managed vehicle includes a collision management system 205. The collision management system includes the computer readable media 240 storing the collision management algorithm 210 having a rule-set that includes preferences utilizable in determining a management of a possible collision between the collision-managed vehicle and the external object 299. A preference of the rule-set includes a vehicle collision management preference inputted by the human user 295 of the collision-managed vehicle. The system includes the damage mitigation circuit 220 configured to determine in at least substantially real time a collision mitigation strategy applicable to the collision-managed vehicle. The collision mitigation strategy is determined in response to the collision management algorithm with the inputted vehicle collision management preference incorporated therein. The system includes the instruction generator circuit 230 configured to generate the collision management instruction responsive to the determined collision mitigation strategy and output the collision management instruction to the vehicle operations controller.

In an embodiment, the collision mitigation strategy is further determined in response to a predicted likelihood of a collision between the collision-managed vehicle 203 and a particular external object 299. In an embodiment, the collision mitigation strategy is further determined in response to data indicative of an environment or situation external or internal to the collision-managed vehicle. In an embodiment, the vehicle operations controller 280 is further configured to control a protective device system of the collision-managed vehicle.

In an embodiment, the collision management system 205 includes a receiver circuit 260 configured to receive the vehicle collision management preference inputted by the human user 295. In an embodiment, the collision management system includes a reporting system configured to output a human perceivable report indicating an active vehicle collision management preference.

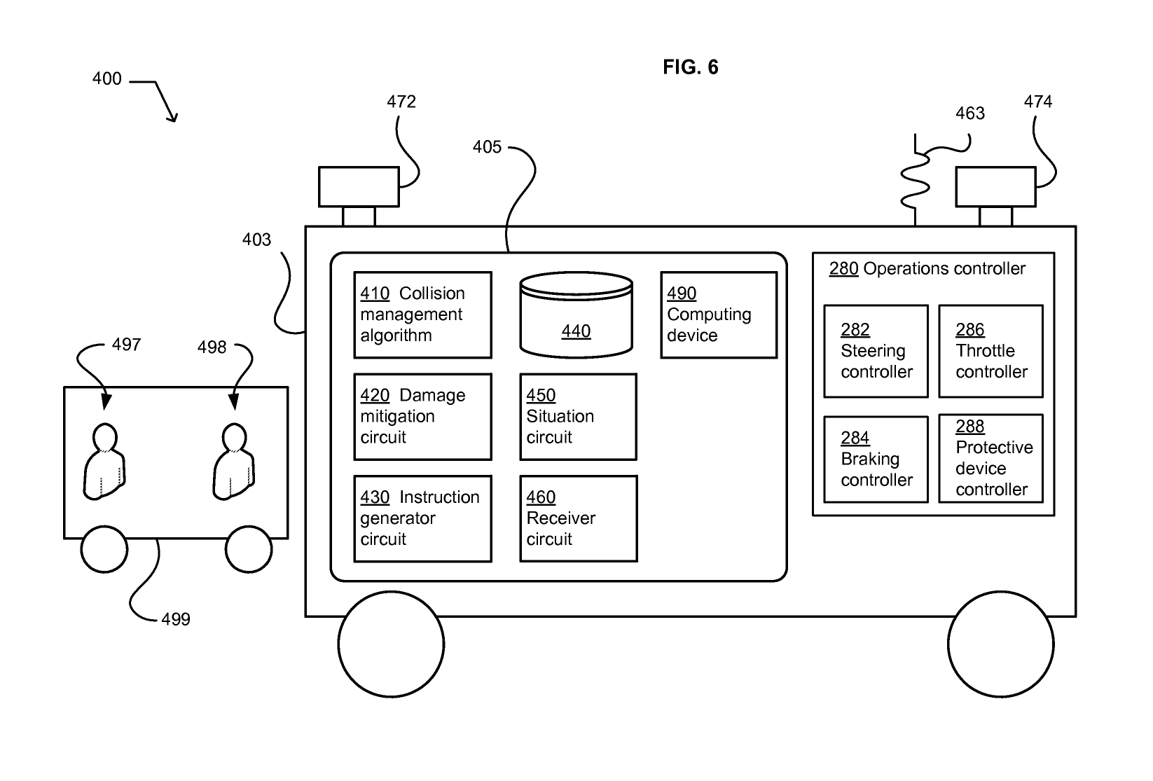

FIG. 6 schematically illustrates an environment 400 in which embodiments may be implemented. The environment includes a collision-managed vehicle 403 and an approaching vehicle 499. The collision-managed vehicle includes a system 405 which is schematically illustrated in FIG. 6. The system includes a computer readable storage media 440 storing a collision management algorithm 410 utilizable in determining a management of a possible collision between the collision-managed vehicle and the approaching vehicle. The collision management algorithm is responsive to sensor-acquired data descriptive or indicative of at least one occupant of the approaching vehicle. The at least one occupant of the approaching vehicle is illustrated as an occupant 497 and an occupant 498. In an embodiment, the occupant 497 is the driver of the approaching vehicle. In an embodiment, the occupant 498 is a passenger of the approaching vehicle. In an embodiment, the collision management algorithm is utilizable in determining a best management of a possible collision between the collision-managed vehicle and the approaching vehicle. The system includes a damage mitigation circuit 420 configured to determine in at least substantially real time a collision mitigation strategy applicable to the collision-managed vehicle. The collision mitigation strategy is determined in response to (i) the collision management algorithm, (ii) sensor-acquired data descriptive or indicative of at least one occupant of the approaching vehicle, and (iii) a predicted likelihood of a collision between the collision-managed vehicle and the approaching vehicle. The system includes an instruction generator circuit 430 configured to generate a collision management instruction responsive to the determined collision mitigation strategy.

In an embodiment, the sensor-acquired data includes data descriptive or indicative of demographic information of the at least one occupant. For example, demographic information may include age and sex. For example, the demographic information may be acquired or developed using optical recognition and classification of the sensor-acquired data. In an embodiment, the sensor-acquired data includes an identifier or an identification of the at least one occupant of the approaching vehicle. In an embodiment, the identification of at least one occupant includes an identification of a disability or medical issue of the at least one occupant. In an embodiment, the identification includes identification of the at least one occupant derived from identifying the approaching vehicle, and accessing a database indicative of an identification of an owner or a family member of the approaching car owner. In an embodiment, the identification includes an identification of at least one occupant based upon a facial recognition process.

In an embodiment, the system 405 includes a sensor 472 configured to acquire the data descriptive or indicative of the at least one occupant of the approaching vehicle 499. In an embodiment, the approaching vehicle is an approaching vehicle having a possibility of colliding with the collision-managed vehicle 403. In an embodiment, the sensor includes an imaging device. In an embodiment, the imaging device includes an optical, infrared, radar, or ultrasound based imaging device. For example, an optical imaging device may include a passive optical imaging device or an active optical imaging device, such as a LIDAR device.

In an embodiment, the collision mitigation strategy includes selecting or controlling an impact site of the collision-managed vehicle 403 with the approaching vehicle 499. For example, the collision mitigation strategy can preferentially impact a site in the approaching vehicle near a male adult occupant of the approaching vehicle over a baby, a kid, a woman, or an infirm person. In an embodiment, the collision mitigation strategy includes selecting or controlling an impact site of the collision-managed vehicle with the approaching vehicle based upon a collision resistance of the approaching vehicle. For example, the collision resistance may be acquired based on an identification of the approaching vehicle. For example, impact site selection may be based on approaching vehicle's identification, and information about its airbags, seatbelts, or other active or passive devices.

In an embodiment, the system 405 includes another sensor 474 configured to acquire data indicative of an environment or situation external to the collision-managed vehicle. In an embodiment, the collision mitigation strategy is further determined in response to (iv) data indicative of an environment or situation external to the collision-managed vehicle.

In an embodiment, the system 405 includes a computer readable storage media 440 configured to save the collision management algorithm 410. In an embodiment, the system includes a situation circuit 450 configured to predict in at least substantially real time the likelihood of a collision between the collision-managed vehicle 403 and the approaching vehicle 499. In an embodiment, the system includes a receiver circuit 460 configured to wirelessly 463 communicate with third-party devices. In an embodiment, the system may be implemented in whole or in part by a computing device 490. For example, the computing device may be implemented in whole or in part using the thin computing device 20 described in conjunction with FIG. 1, and or by the general purpose computing device 110 described in conjunction with FIG. 2.

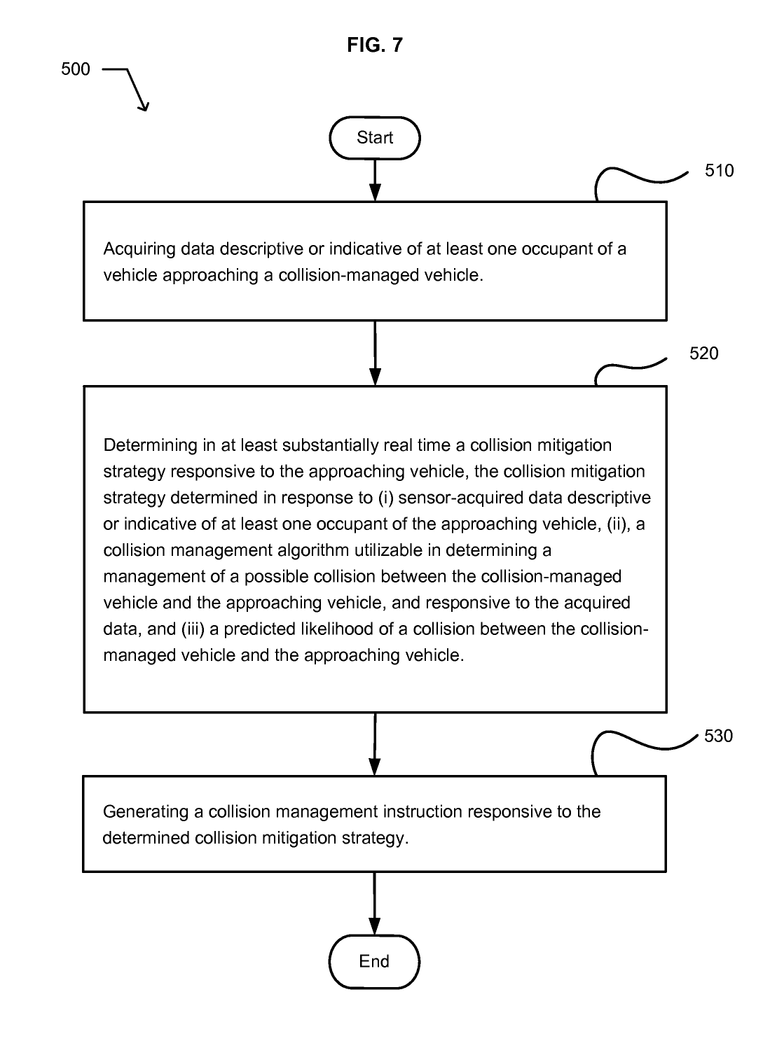

FIG. 7 illustrates an example operational flow 500. After a start operation, the operational flow includes an acquisition operation 510. The acquisition operation includes acquiring data descriptive or indicative of at least one occupant of a vehicle approaching a collision-managed vehicle. In an embodiment, the acquisition operation may be implemented using the sensor 472 described in conjunction with FIG. 6. A strategizing operation 520 includes determining in at least substantially real time a collision mitigation strategy responsive to the approaching vehicle. The collision mitigation strategy is determined in response to (i) sensor-acquired data descriptive or indicative of at least one occupant of the approaching vehicle; (ii), a collision management algorithm utilizable in determining a management of a possible collision between the collision-managed vehicle and the approaching vehicle, the collision management algorithm responsive to the acquired data; and (iii) a predicted likelihood of a collision between the collision-managed vehicle and the approaching vehicle. In an embodiment, the strategizing operation may be implemented using the collision management algorithm 410 stored on the computer readable media 440 and the damage mitigation circuit 420 described in conjunction with FIG. 6. In an embodiment, the strategizing operation may be performed in part or whole using the computing device 490. An implementation operation 530 includes generating a collision management instruction responsive to the determined collision mitigation strategy. In an embodiment, the implementation operation may be implemented using the instruction generator circuit 430 described in FIG. 6. The operational flow includes an end operation.

In an embodiment of the acquisition operation 510, the acquiring data includes acquiring data descriptive or indicative of at least one occupant of the approaching vehicle using a sensor carried by the collision-managed vehicle. In an embodiment of the strategizing operation 520, the collision mitigation strategy is further determined in response to (iv) data indicative of an environment or situation presented by the approaching vehicle and the collision-managed vehicle. In an embodiment of the strategizing operation 520, the collision management algorithm includes a collision management algorithm utilizable in determining a best management of a possible collision between the collision-managed vehicle and the approaching vehicle.

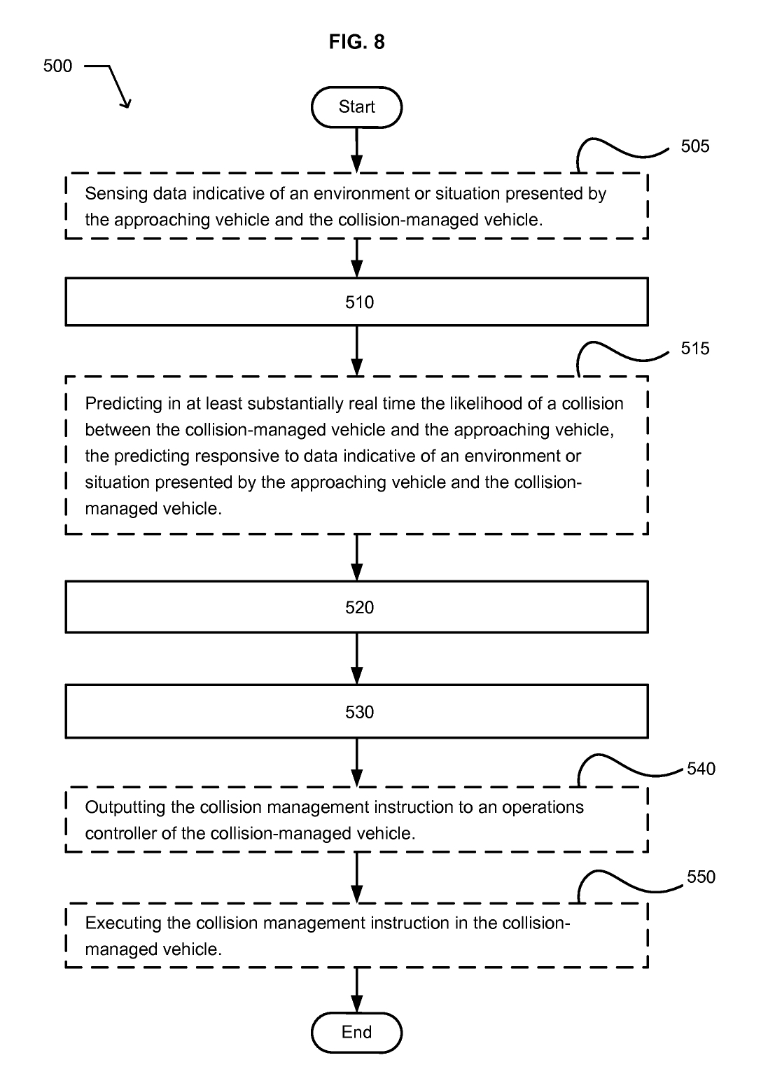

FIG. 8 illustrates an alternative embodiment of the operational flow 500 of FIG. 7. The operational flow may include an operation 505, an operation 515, an operation 540, or an operation 550. The operation 505 includes sensing data indicative of an environment or situation presented by the approaching vehicle and the collision-managed vehicle. The operation 515 includes predicting in at least substantially real time the likelihood of a collision between the collision-managed vehicle and the approaching vehicle. The predicting is responsive to data indicative of an environment or situation presented by the approaching vehicle and the collision-managed vehicle. The operation 540 includes outputting the collision management instruction to an operations controller of the collision-managed vehicle. The operation 550 includes executing the collision management instruction in the collision-managed vehicle.

Returning to FIG. 6, FIG. 6 also illustrates an embodiment of the collision-managed vehicle 403. The collision-managed vehicle includes the vehicle operations controller 280 configured to control at least one of a propulsion system, a steering system, or a braking system of the collision-managed vehicle in response to a collision management instruction. The collision-managed vehicle includes the sensor 472 configured to acquire data descriptive or indicative of at least one occupant of the approaching vehicle 499. The collision-managed vehicle includes the collision management system 405. The collision management system includes the computer readable storage media 440 storing the collision management algorithm 410 utilizable in determining a management of a possible collision between the collision-managed vehicle and the approaching vehicle. The collision management algorithm is responsive to the sensor-acquired data descriptive or indicative of the at least one occupant of the approaching vehicle. The collision management system includes the damage mitigation circuit 420 configured to determine in at least substantially real time a best collision mitigation strategy applicable to the collision-managed vehicle. The collision mitigation strategy is determined in response to (i) the collision management algorithm, (ii) the sensor-acquired data descriptive or indicative of at least one occupant of the approaching vehicle, and (iii) a predicted likelihood of a collision between the collision-managed vehicle and the approaching vehicle. The collision management system includes the instruction generator circuit configured to generate the collision management instruction responsive to the determined collision mitigation strategy.

In an embodiment, the sensor 472 is configured to acquire data descriptive or indicative of at least one occupant of the approaching vehicle 499 having a possibility of colliding with the collision-managed vehicle 403.

Returning to FIG. 3, FIG. 3 illustrates an alternative embodiment of the system 205. In this embodiment, the system includes the computer readable media 240 storing the collision management algorithm 210 having a rule-set that includes preferences utilizable in determining a management of a possible collision between the collision-managed vehicle 206 and the external object 299. The rule-set is configured to incorporate vehicle collision management preferences respectively inputted by at least two human users or occupants of the collision-managed vehicle. The at least two human users or occupants are illustrated by the owner or human driver 295, and the human passenger 296. The system includes the damage mitigation circuit 220 configured to determine in at least substantially real time a collision mitigation strategy applicable to the collision-managed vehicle. The collision mitigation strategy is determined in response to (i) the collision management algorithm with the inputted vehicle collision management preferences incorporated therein, and (ii) a predicted likelihood of a collision between the collision-managed vehicle and the external object. The system includes the instruction generator circuit 230 configured to generate a collision management instruction responsive to the determined collision mitigation strategy.

In an embodiment of the system 205, the incorporating the at least two vehicle collision management preferences includes a weighing or prioritizing of the vehicle collision management preferences respectively inputted by at least two human users or occupants. In an embodiment, the weighing or prioritizing is responsive to a role in the operation of the collision-managed vehicle by the human-user submitting the collision management preference. For example, the rule-set can give a higher weight to a driver, owner, baby, women, pregnant women, or physically impaired or infirm. For example, the weights can be relative. For example, in the event of a conflict, one user's preference may always control, such as the preference of the driver 295. In an embodiment, the weighing or prioritizing is responsive to a relationship between a prospective collision avoidance maneuver of the collision-managed vehicle in a possible determined collision mitigation strategy and the human-user submitting the collision management preference. For example, different aspects of the preferences can be weighted differently for different occupants, i.e., driver rules on maneuver limits, but babies rule on collision severity. In an embodiment, the weighing or prioritizing is responsive to a relationship between a location in the collision-managed vehicle of the human-user submitting the collision management preference and a predicted collision impact region of the collision-managed vehicle with the external object. For example, collision severity weights can depend on a location of the occupant. For instance, front seat occupants may dominate for frontal collisions, while rear seat occupants may dominate for rear-end collisions. For example, decisions may depend on locational countermeasures or on occupant fragility. In an embodiment, the collision management strategy is further determined in response to (iii) data indicative of an environment or situation external or internal to the collision-managed vehicle.

In an embodiment, the system 205 includes the receiver circuit 260 configured to receive the collision management preferences for the collision-managed vehicle 206 respectively inputted by the at least two human users or occupants 295-296. In an embodiment, the system includes a reporting system 270 configured to output a human perceivable report indicating one or more active vehicle collision management preferences. For example, the human perceivable report may be viewable or accessible by the human user or other occupant of the collision-managed vehicle.

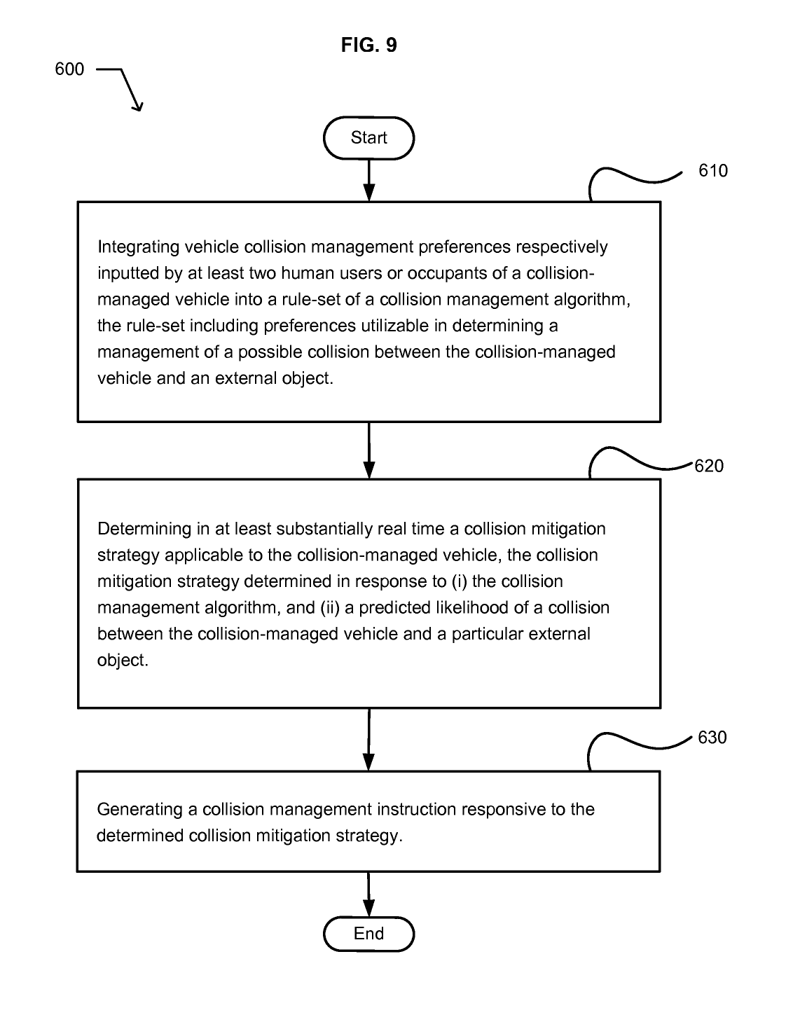

FIG. 9 illustrates an example operational flow 600 implemented in a computing device. After a start operation, the operational flow includes an incorporation operation 610. The incorporation operation includes integrating vehicle collision management preferences respectively inputted by at least two human users or occupants of a collision-managed vehicle into a rule-set of a collision management algorithm. The rule-set including preferences utilizable in determining a management of a possible collision between the collision-managed vehicle and an external object. In an embodiment, the incorporation operation may be implemented by the receiver circuit 260 receiving the collision management preference inputted by the at least human users 295 and 296, and the computing device 290 incorporating the received collision management preference into the rule-set of the collision management algorithm 210 stored in the computer readable media 240 described in conjunction with FIG. 3. A strategizing operation 620 includes determining in at least substantially real time a collision mitigation strategy applicable to the collision-managed vehicle. The collision mitigation strategy is determined in response to (i) the collision management algorithm, and (ii) a predicted likelihood of a collision between the collision-managed vehicle and a particular external object. In an embodiment, the strategizing operation may be implemented using the damage mitigation circuit 220 described in conjunction with FIG. 3. An implementation operation 630 includes generating a collision management instruction responsive to the determined collision mitigation strategy. In an embodiment, the implementation operation may be implemented using the instruction generator circuit 230 described in conjunction with FIG. 3. The operational flow includes an end operation.

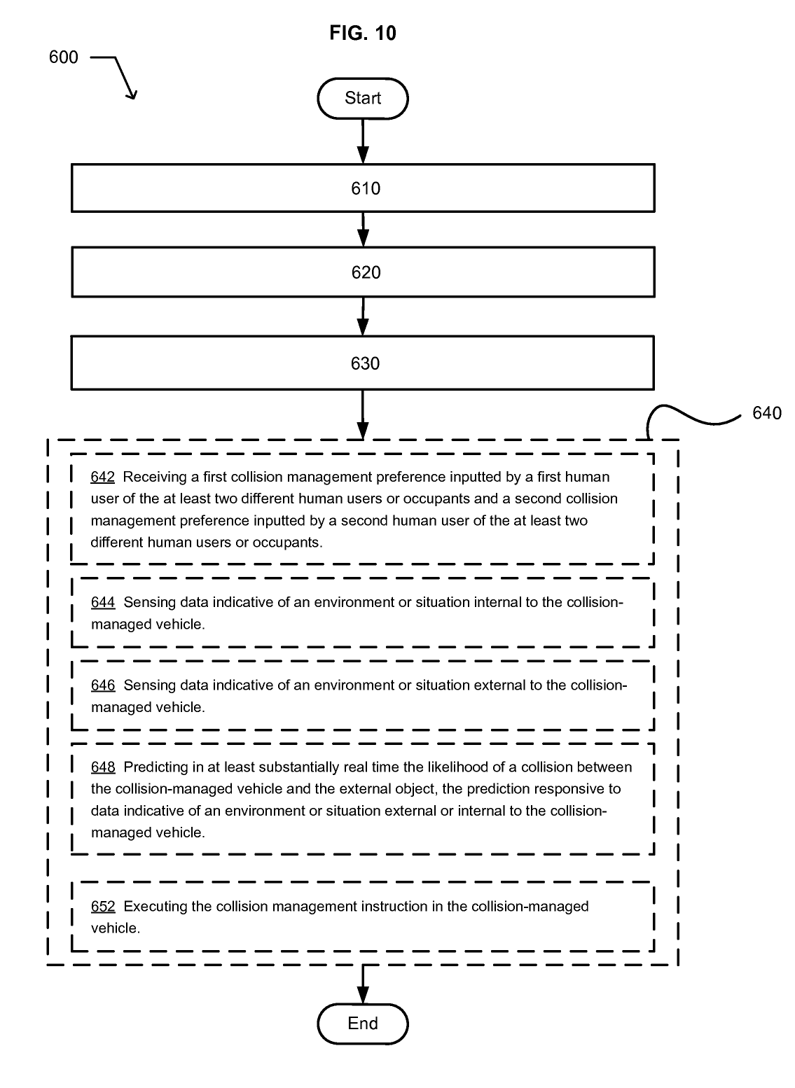

FIG. 10 illustrates an alternative embodiment of the operational flow 600 of FIG. 9. In an embodiment, the operational flow may include at least one additional operation 640. The at least one additional operation may include an operation 642 receiving a first collision management preference inputted by a first human user of the at least two different human users or occupants and a second collision management preference inputted by a second human user of the at least two different human users or occupants. The at least one additional operation may include an operation 644 sensing data indicative of an environment or situation internal to the collision-managed vehicle. For example, the sensed data may include a number or placement of occupants in the collision-managed vehicle. For example, the sensed data may include a characterization, such as young, old, robust, or infirm of occupants in the collision-managed vehicle. The at least one additional operation may include an operation 646 sensing data indicative of an environment or situation external of the collision-managed vehicle. For example, the environment or situation may include sensing data indicative of an approaching vehicle, approaching roadway hazard, or an available escape path. The at least one additional operation may include an operation 648 predicting in at least substantially real time the likelihood of a collision between the collision-managed vehicle and the external object. The prediction is responsive to data indicative of an environment or situation external or internal to the collision-managed vehicle. The at least one additional operation may include an operation 652 executing the collision management instruction in the collision-managed vehicle.

All references cited herein are hereby incorporated by reference in their entirety or to the extent their subject matter is not otherwise inconsistent herewith.

In some embodiments, “configured” includes at least one of designed, set up, shaped, implemented, constructed, or adapted for at least one of a particular purpose, application, or function.

It will be understood that, in general, terms used herein, and especially in the appended claims, are generally intended as “open” terms. For example, the term “including” should be interpreted as “including but not limited to.” For example, the term “having” should be interpreted as “having at least.” For example, the term “has” should be interpreted as “having at least.” For example, the term “includes” should be interpreted as “includes but is not limited to,” etc. It will be further understood that if a specific number of an introduced claim recitation is intended, such an intent will be explicitly recited in the claim, and in the absence of such recitation no such intent is present. For example, as an aid to understanding, the following appended claims may contain usage of introductory phrases such as “at least one” or “one or more” to introduce claim recitations. However, the use of such phrases should not be construed to imply that the introduction of a claim recitation by the indefinite articles “a” or “an” limits any particular claim containing such introduced claim recitation to inventions containing only one such recitation, even when the same claim includes the introductory phrases “one or more” or “at least one” and indefinite articles such as “a” or “an” (e.g., “a receiver” should typically be interpreted to mean “at least one receiver”); the same holds true for the use of definite articles used to introduce claim recitations. In addition, even if a specific number of an introduced claim recitation is explicitly recited, it will be recognized that such recitation should typically be interpreted to mean at least the recited number (e.g., the bare recitation of “at least two chambers,” or “a plurality of chambers,” without other modifiers, typically means at least two chambers).

In those instances where a phrase such as “at least one of A, B, and C,” “at least one of A, B, or C,” or “an [item] selected from the group consisting of A, B, and C,” is used, in general such a construction is intended to be disjunctive (e.g., any of these phrases would include but not be limited to systems that have A alone, B alone, C alone, A and B together, A and C together, B and C together, or A, B, and C together, and may further include more than one of A, B, or C, such as A₁, A₂, and C together, A, B₁, B₂, C₁, and C₂ together, or B₁ and B₂ together). It will be further understood that virtually any disjunctive word or phrase presenting two or more alternative terms, whether in the description, claims, or drawings, should be understood to contemplate the possibilities of including one of the terms, either of the terms, or both terms. For example, the phrase “A or B” will be understood to include the possibilities of “A” or “B” or “A and B.”

The herein described aspects depict different components contained within, or connected with, different other components. It is to be understood that such depicted architectures are merely examples, and that in fact many other architectures can be implemented which achieve the same functionality. In a conceptual sense, any arrangement of components to achieve the same functionality is effectively “associated” such that the desired functionality is achieved. Hence, any two components herein combined to achieve a particular functionality can be seen as “associated with” each other such that the desired functionality is achieved, irrespective of architectures or intermedial components. Likewise, any two components so associated can also be viewed as being “operably connected,” or “operably coupled,” to each other to achieve the desired functionality. Any two components capable of being so associated can also be viewed as being “operably couplable” to each other to achieve the desired functionality. Specific examples of operably couplable include but are not limited to physically mateable or physically interacting components or wirelessly interactable or wirelessly interacting components.

With respect to the appended claims the recited operations therein may generally be performed in any order. Also, although various operational flows are presented in a sequence(s), it should be understood that the various operations may be performed in other orders than those which are illustrated, or may be performed concurrently. Examples of such alternate orderings may include overlapping, interleaved, interrupted, reordered, incremental, preparatory, supplemental, simultaneous, reverse, or other variant orderings, unless context dictates otherwise. Use of “Start,” “End,” “Stop,” or the like blocks in the block diagrams is not intended to indicate a limitation on the beginning or end of any operations or functions in the diagram. Such flowcharts or diagrams may be incorporated into other flowcharts or diagrams where additional functions are performed before or after the functions shown in the diagrams of this application. Furthermore, terms like “responsive to,” “related to,” or other past-tense adjectives are generally not intended to exclude such variants, unless context dictates otherwise.

While various aspects and embodiments have been disclosed herein, other aspects and embodiments will be apparent to those skilled in the art. The various aspects and embodiments disclosed herein are for purposes of illustration and are not intended to be limiting, with the true scope and spirit being indicated by the following claims.

What is claimed is:

1. A system comprising:
a computer readable storage media storing a collision management algorithm having a rule-set that includes preferences utilizable in determining a management of a possible collision between a collision-managed vehicle and an external object, a preference of the rule-set includes a vehicle collision management preference inputted by a human user of the collision-managed vehicle;
a damage mitigation circuit configured to determine in at least substantially real time a collision mitigation strategy applicable to the collision-managed vehicle, the collision mitigation strategy determined in response to (i) the collision management algorithm with the inputted vehicle collision management preference incorporated therein, and (ii) a predicted likelihood of a collision between the collision-managed vehicle and a particular external object; and
an instruction generator circuit configured to generate a collision management instruction responsive to the determined collision mitigation strategy.

2. The system of claim 1, wherein the human user includes a driver, owner, or passenger of the collision-managed vehicle.

3. (canceled)

4. (canceled)

5. The system of claim 1, wherein the vehicle collision management preference includes personalized rules addressing different types of external objects, maneuvering limits in avoiding external objects, or levels of risk posed by external objects.

6. The system of claim 1, wherein the vehicle collision management preference includes a relative preference of a collision with an inanimate external object over a human being or animal, or a relative preference of a collision with an animal over a human being.

7. (canceled)

8. The system of claim 1, wherein the vehicle collision management preference includes a relative preference of a collision with one type or category of a human over another type or category of a human.

9. (canceled)

10. The system of claim 1, wherein the vehicle collision management preference includes a relative preference of a collision with an external object that impacts an impact absorbing zone of the collision-managed vehicle over a collision that impacts a non-impact absorbing zone, or a relative preference of a collision with an external object that impacts a region having a deployable impact absorbing device of the vehicle over a region not having a deployable impact absorbing device.

11. (canceled)

12. The system of claim 1, wherein the vehicle collision management preference includes a relative preference of a collision impacting a low kinetic energy external object over a high kinetic energy object, or a collision mode having a lower peak impulse flux density over a collision mode having a higher peak impulse flux density.

13. (canceled)

14. (canceled)

15. The system of claim 1, wherein the vehicle collision management preference includes a relative preference of a collision mode having lower likelihood of a severe trauma to an occupant of the collision-managed vehicle over a collision mode having a higher likelihood of a severe trauma to the occupant, or of a collision with an external object impacting a region of the collision-managed vehicle occupied by a robust human over a region of the collision-managed vehicle occupied by an at-risk or infirm human.

16. (canceled)

17. The system of claim 1, wherein the vehicle collision management preference includes a relative preference of a collision causing financial damage below a threshold value to the collision-managed vehicle over hitting an animal.

18. (canceled)

19. The system of claim 1, wherein the vehicle collision management preference includes a relative preference of a collision impacting a protected occupant over an unprotected occupant, or of a collision adversely impacting an occupant of the collision-managed vehicle over a pedestrian.

20. (canceled)

21. The system of claim 1, wherein the vehicle collision management preference includes a relative preference of limiting a potential injury to an occupant of the collision-managed vehicle caused by an avoidance maneuver over a potential injury due to a collision with the external object.

22. The system of claim 1, wherein the vehicle collision management preference includes a limit on g-forces imparted to the human user or other occupant of the collision-managed vehicle.

23. (canceled)

24. The system of claim 1, wherein the vehicle collision management preference includes a preference on maneuvering limits, on acceptable collision severity, on treating personal damage versus property damage, on how to treat different obstacles, or on protection countermeasures.

25. The system of claim 1, wherein the vehicle collision management preference includes a preference responsive to a likelihood of the collision-managed vehicle actually being able to implement the mitigation strategy.

26.-28. (canceled)

29. The system of claim 1, wherein the vehicle collision management preference includes a vehicle collision management preference stored in a key fob, cellular phone, or RFID tag carryable by the human user.

30. (canceled)

31. The system of claim 1, wherein the rule-set of the collision mitigation algorithm is further responsive to an extent or difficulty of a maneuver required to prevent a collision with the external object.

32. The system of claim 1, wherein the rule-set of the collision mitigation algorithm is further responsive to a risk of a collision with another external object associated with an avoidance maneuver.

33. The system of claim 1, wherein the rule-set of the collision mitigation algorithm is further responsive to a prioritization among multiple external objects that may potentially be hit.

34. The system of claim 1, wherein the collision mitigation strategy is further determined in response to (iii) data indicative of an environment or situation external to the collision-managed vehicle.

35. The system of claim 1, wherein the instruction generator circuit is further configured to output the collision management instruction to an operations controller of the collision-managed vehicle configured to implement the collision management instruction.

36. The system of claim 35, wherein the operations controller includes a steering controller of the collision-managed vehicle.

37. The system of claim 35, wherein the operations controller includes a braking controller of the collision-managed vehicle.

38. The system of claim 35, wherein the operations controller includes a throttle controller of the collision-managed vehicle.

39. The system of claim 35, wherein the operations controller includes a protective device controller of the collision-managed vehicle.

40. The system of claim 1, further comprising:
a situation circuit configured to predict in at least substantially real time the likelihood of a collision between the collision-managed vehicle and the external object, the prediction responsive to data indicative of an environment or situation external or internal to the collision-managed vehicle.

41. (canceled)

42. The system of claim 1, further comprising:
a first sensor configured to acquire data indicative of an environment or situation internal to the collision-managed vehicle.

43. (canceled)

44. The system of claim 1, further comprising:
a second sensor configured to acquire data indicative of an environment or situation external to the collision-managed vehicle.

45. The system of claim 44, wherein the second sensor is configured to acquire data indicative of a human or animal external to the collision-managed vehicle.

46. (canceled)

47. The system of claim 44, wherein the second sensor is configured to acquire data indicative of another vehicle proximate to the collision-managed vehicle.

48. (canceled)

49. The system of claim 44, wherein the second sensor is further configured to identify or classify at least one external object proximate to the collision-managed vehicle.

50. (canceled)

51. The system of claim 1, further comprising:
a reporting system configured to output a human perceivable report indicating an active vehicle collision management preference.

52. (canceled)

53. A system comprising:
a damage mitigation circuit configured to determine in at least substantially real time a collision mitigation strategy applicable to a collision-managed vehicle, the collision mitigation strategy determined in response to (i) a collision management algorithm having a rule-set that includes preferences utilizable in determining a best management of a possible collision between the collision-managed vehicle and an external object, (ii) a vehicle collision management preference inputted by a human user of the collision-managed vehicle, and (iii) a predicted likelihood of a collision between the collision-managed vehicle and the external object; and
an instruction generator circuit configured to generate a collision management instruction responsive to the determined collision mitigation strategy.

54. A method implemented in a computing device, the method comprising:
integrating a collision management preference inputted by a human user of a collision-managed vehicle into a rule-set of a collision management algorithm, the rule-set including preferences utilizable in determining a management of a possible collision between the collision-managed vehicle and an external object;
determining in at least substantially real time a collision mitigation strategy applicable to the collision-managed vehicle, the collision mitigation strategy determined in response to (i) the collision management algorithm with the integrated user inputted collision management preference, and (ii) a predicted likelihood of a collision between the collision-managed vehicle and a particular external object; and
generating a collision management instruction responsive to the determined collision mitigation strategy.

55. The method of claim 54, wherein the collision mitigation strategy is further determined in response to data indicative of an environment or situation external or internal to the collision-managed vehicle.

56. (canceled)

57. The method of claim 54, further comprising:
sensing data indicative of an environment or situation internal to the collision-managed vehicle.

58. The method of claim 54, further comprising:
sensing data indicative of an environment or situation external of the collision-managed vehicle.

59. The method of claim 54, further comprising:
predicting in at least substantially real time the likelihood of a collision between the collision-managed vehicle and the external object, the prediction responsive to data indicative of an environment or situation external or internal to the collision-managed vehicle.

60. The method of claim 54, further comprising:
executing the collision management instruction in the collision-managed vehicle.

61. A collision-managed vehicle comprising:
a vehicle operations controller configured to control at least one of a propulsion system, a steering system, or a braking system of the collision-managed vehicle in response to a collision management instruction; and
a collision management system comprising:
a computer readable storage media storing a collision management algorithm having a rule-set that includes preferences utilizable in determining a management of a possible collision between a collision-managed vehicle and an external object, a preference of the rule-set including a vehicle collision management preference inputted by a human user of the collision-managed vehicle;
a damage mitigation circuit configured to determine in at least substantially real time a collision mitigation strategy applicable to the collision-managed vehicle, the collision mitigation strategy determined in response to the collision management algorithm with the inputted vehicle collision management preference incorporated therein; and
an instruction generator circuit configured to generate the collision management instruction responsive to the determined collision mitigation strategy and output the collision management instruction to the vehicle operations controller.

62. The vehicle of claim 61, wherein the collision mitigation strategy is determined in response to a predicted likelihood of a collision between the collision-managed vehicle and a particular external object.

63. The vehicle of claim 61, wherein the collision mitigation strategy is determined in response to data indicative of an environment or situation external or internal to the collision-managed vehicle.

64.-66. (canceled)
